(19) United States
(12) Patent Application Publication
(10) Pub. No.: US 2025/0240377 A1
(43) Pub. Date: Jul. 24, 2025

(54) INFORMATION PROCESSING APPARATUS, CONTROL METHOD OF INFORMATION PROCESSING APPARATUS, AND STORAGE MEDIUM

(71) Applicant: CANON KABUSHIKI KAISHA, Tokyo (JP)

(72) Inventor: SATOSHI TAKAZAWA, Kanagawa (JP)

(21) Appl. No.: 19/032,857

(22) Filed: Jan. 21, 2025

(30) Foreign Application Priority Data
Jan. 24, 2024 (JP) 2024-008644

(51) Int. Cl. H04N 1/00

(52) U.S. Cl. CPC H04N 1/00968; H04N 1/00334; H04N 1/0048; H04N 2201/0094

(57) ABSTRACT

An information processing apparatus is provided and enables a user to selectively apply setting data the user desires to be applied to target equipment. Information on various setting values is obtained from a scanned image of a sheet on which information on various setting values applicable to the information processing apparatus is printed. Then, based on the obtained information, a setting value designated by a user among the various setting values is applied to the information processing apparatus.

### BACKGROUND

### Field

The present disclosure relates to an information processing apparatus, a control method of an information processing apparatus, and a storage medium.

### Description of the Related Art

Conventionally, as the method of backing up setting data, restoring backed-up setting data and so on for an information processing apparatus, such as a multi-function peripheral, a method using barcode is known. For example, Japanese Patent Laid-Open No. 2002-44299 has disclosed a method of enabling manual registration of setting data by collating barcode and a character string even in a case where the barcode is stained and cannot be decoded by describing and printing both the barcode obtained by encoding the setting data and the character string indicating the contents of the setting data.

There is a case where only part of conventional setting data, not all of it, is desired to be applied in a scene in which a failed apparatus is installed again after it is repaired or in which the same type of the existing apparatus is purchased additionally and used for extension,. For example, in a case of a multi-function peripheral, it may happen that a user desires to apply the printing setting, such as 2in1 and single-sided/double-sided printing, but does not desire to apply the network setting because the user desires to use another fixed IP address. It is not possible for the prior art including that disclosed in Japanese Patent Laid-Open No. 2002-44299 described above to deal with such a case where only part of the conventional setting data is desired to be applied to the target equipment as described above.

### SUMMARY OF THE DISCLOSURE

The information processing apparatus according to the present disclosure includes: an obtaining unit configured to obtain, from a scanned image of a sheet on which information on various setting values applicable to the information processing apparatus is printed, the various setting values; and an application unit configured to apply a setting value designated by a user among the various setting values to the information processing apparatus based on the obtained information.

Further features of the present disclosure will become apparent from the following description of exemplary embodiments with reference to the attached drawings.

### BRIEF DESCRIPTION OF THE DRAWINGS

FIG. 1 is a block diagram showing a hardware configuration of a multi-function peripheral;

FIG. 2 is a function block diagram showing a software configuration of a multi-function peripheral 100;

FIG. 3 is a flowchart showing a flow of backup processing of setting data;

FIG. 4 is a diagram showing the way a setting value is converted into QR code;

FIG. 5 is a diagram showing one example of a setting UI screen;

FIG. 6A is a diagram showing one example of a backup image and FIG. 6B is a diagram showing one example of a backup sheet to which a checkmark has been input;

FIG. 7 is a flowchart showing a flow of restoration processing of setting data according to a first embodiment;

FIG. 8A is a diagram showing one example of a restoration UI screen and FIG. 8B is a diagram showing one example of a mark with which the portion relating to a setting value for which restoration is not necessary is filled in;

FIG. 9A to FIG. 9C are each a diagram showing one example of a restoration guide UI screen;

FIG. 10 is a diagram showing the way a message screen prompting execution of backup processing is displayed in a popup manner;

FIG. 11 is a diagram showing the relationship between FIG. 11A and FIG. 11B;

FIG. 11A is a flowchart showing a flow of restoration processing of setting data according to a second embodiment;

FIG. 11B is a flowchart showing a flow of processing following FIG. 11A; and

FIG. 12 is a diagram showing one example of a backup sheet to which a checkmark has been input.

### DESCRIPTION OF THE EMBODIMENTS

In the following, aspects for performing the present embodiments are explained with reference to the drawings and the like. The following embodiments are not intended to limit the technique of the present disclosure and all configurations explained in the following embodiments are not necessarily indispensable to the solution for solving the problem.

### First Embodiment

### Hardware Configuration

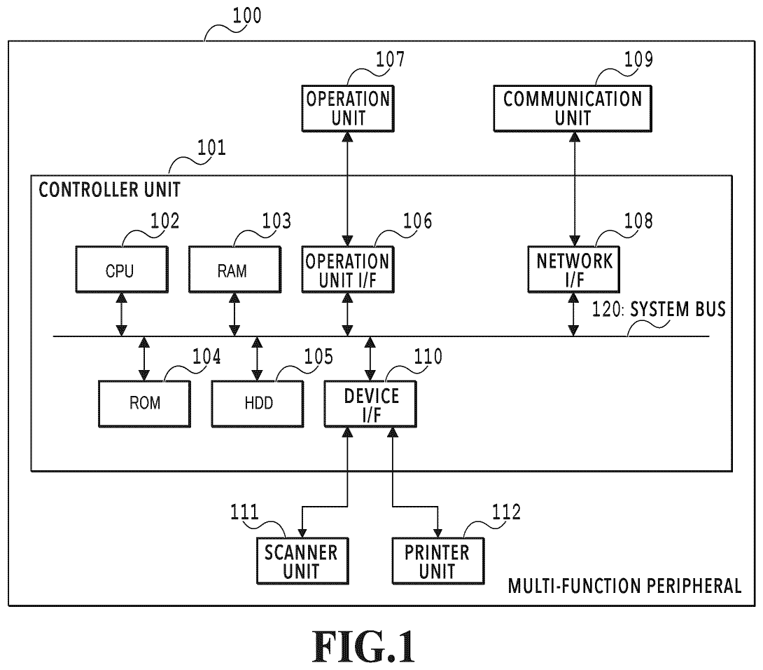

FIG. 1 is a block diagram showing the hardware configuration of a multi-function peripheral having a plurality of functions, such as a printing function and a scan function. A multi-function peripheral 100 has a controller unit 101 and the controller unit 101 controls a scanner unit 111, a printer unit 112, an operation unit 107, and a communication unit 109. In a case where a user utilizes a copy function, the controller unit 101 obtains a scanned image by reading a document placed on a document table, not shown schematically, by the scanner unit 111 and causes the printer unit 112 to perform printing based on the scanned image. Further, in a case where a user utilizes a scan function, the controller unit 101 obtains a scanned image by reading a document placed on a document table, not shown schematically, by the scanner unit 111 and transmits the scanned image to an external device (not shown schematically) via the communication unit 109. The instructions to perform processing in each of these functions are called “job” and the multi-function peripheral 100 performs predetermined processing in accordance with the job corresponding to each function.

The controller unit 101 includes a CPU 102, a RAM 103, a ROM 104, an HDD 105, an operation unit I/F 106, a network I/F 108, and a device I/F 110 and those units are connected via a system bus 120. The CPU 102 is a central processing unit configured to control the entire system of the multi-function peripheral 100. The ROM 103 is a system work memory for the CPU 102 to operate by loading programs, such as the operating system and application software, and various pieces of data. Further, the RAM 103 is also an image memory for temporarily storing image data and stores a scanned image read by the scanner unit 111, stores an image to be printed received via the communication unit 109, and so on. The ROM 104 is a nonvolatile memory storing a system boot program and the like. The hard disk drive (HDD) 105 is a large-capacity storage device storing the operating system, application software, various setting values and the like. The operation unit I/F 106 is an interface that outputs a UI screen to be displayed on the display of the operation unit 107 to the operation unit 107 and receives operations of a physical button of the operation unit 107 and user instructions via the UI screen. The network I/F 108 is an interface that performs various kinds of communication control with an external device, not shown schematically, via the communication unit 109. The device I/F 110 is an interface that connects the scanner unit 111 that scans image data and the printer unit 112 that performs printing with the controller unit 101 and performs input/output of image data. The scanner unit 111 performs scan processing to optically read a document placed on a document table, not shown schematically. The printer unit 112 performs print processing for a sheet that is placed on a sheet tray, not shown schematically, based on printing instruction data (PDL data) input from an external device and a scanned image obtained by scan processing. Further, the printer unit 112 also performs print processing of a backup image including code information obtained by encoding various setting values of the multi-function peripheral 100.

The above-described multi-function peripheral is merely one example of an information processing apparatus that is the target of backup and restoration of setting data and the information processing apparatus is not limited to this. For example, the information processing apparatus may be a printer apparatus specialized in the print function, a scanner apparatus specialized in the scan function or the like. It is possible to widely apply the method of the present embodiment to an information processing apparatus whose operation is controlled in accordance with setting data.

### Software Configuration

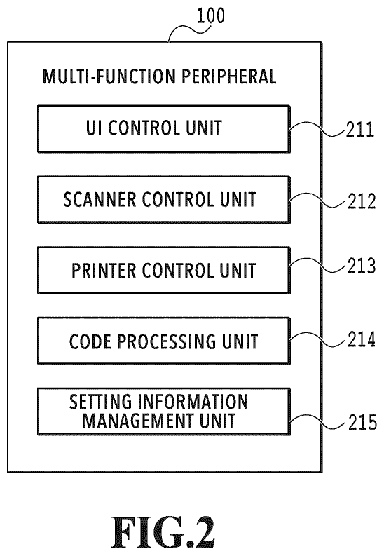

FIG. 2 is a function block diagram showing the software configuration of the multi-function peripheral 100 according to the present embodiment. The function indicated by each block in FIG. 2 is implemented by the CPU 102 reading software stored in the ROM 104 or the HDD 105 onto the RAM 103 and executing the software.

A UI control unit 211 performs control of generation and display of a variety of user interface screens (UI screens) for presenting information necessary for a user, receiving input of information from a user, and so on. A scanner control unit 212 controls the scanner unit 111 via the device I/F 110 and generates image data (scanned image data) by optically reading a document placed on a document table. A printer control unit 213 controls the printer unit 112 via the device I/F 110 and performs print processing for a sheet based on printing image data (halftone image data) converted by various pieces of image processing so that the printer unit 112 can handle the data.

A code processing unit 214 performs code processing to convert various setting values of the multi-function peripheral 100 into code information by encoding them, decode and convert code information into setting values that are applied to the multi-function peripheral 100, and so on. A setting data management unit 215 performs processing to obtain various setting values that are being applied to the apparatus of its own for the backup of the setting data. Further, the setting data management unit 215 performs processing to apply only the necessary setting value by identifying the setting category (same meaning as “setting item”. In the following, simply described as “category”) that should be applied from the scanned image on the backup sheet in order to apply the backed-up setting data to the apparatus of its own.

### Operation of Information Processing Apparatus

### <<During Backup>>

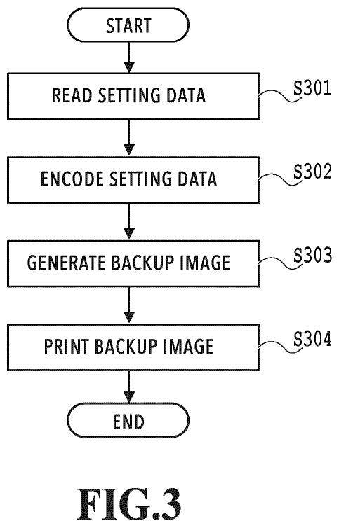

Following the above, with reference to the flowchart in FIG. 3, backup processing of setting data is explained, which is performed by the multi-function peripheral 100 according to the present embodiment. The flowchart in FIG. 3 is implemented by the CPU 102 executing a predetermined program. The CPU 102 starts the backup processing with the reception of user instructions to start the backup processing given on a UI screen, not shown schematically, via the operation unit I/F 106 as a trigger. Alternatively, it may also be possible for the CPU 102 to start the backup processing with the reception of the same instructions given through a Web browser via the network I/F 108 as a trigger. In the following explanation, a symbol “S” means a step.

At S301, the setting data management unit 215 reads all the various setting values that are stored in the HDD 105 or the like and being applied onto the RAM 103. The various setting values that are read here are, for example, character strings, numerical value strings and the like in accordance with each category, such as “2in1” and “double-sided” for the category of “printing setting” and “JP (Japanese)” and “EN (English)” representing the language type for the category of “language setting”. That is, the various setting values are printing settings that are used in a case of equipment setting of the multi-function peripheral and printing.

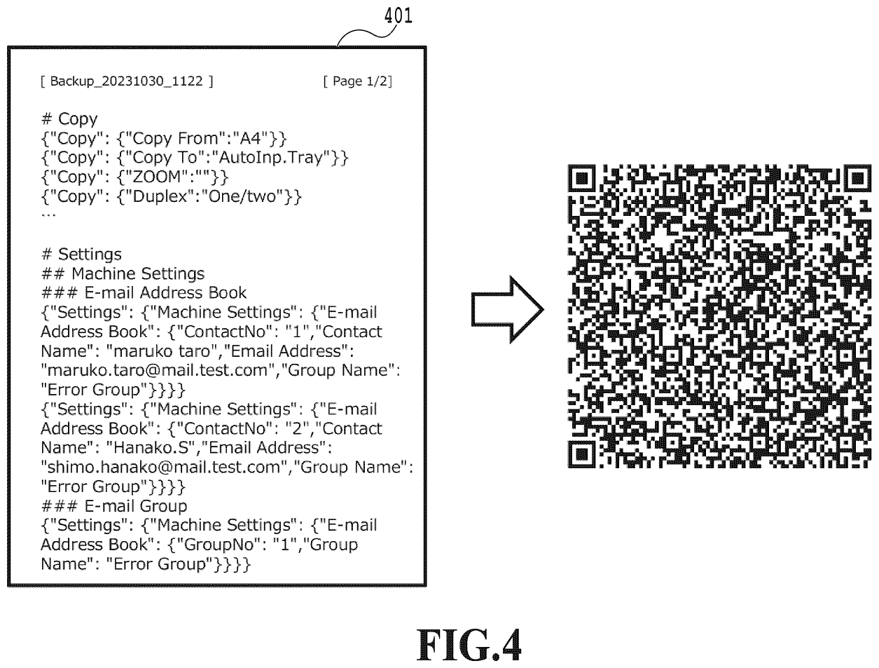

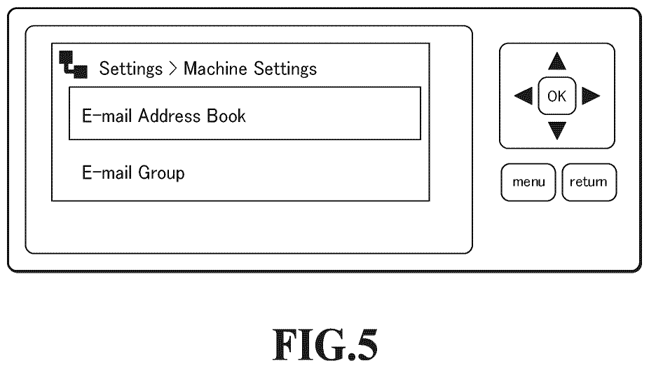

At S302, the code processing unit 214 converts (encodes) various setting values read at S301 into code information. Here, the code information means the read various setting values associated with each category and encoded by, for example, a key-value method, that is, one-directional code, such as a barcode, and two-directional codes, such as a QR code (registered trademark). FIG. 4 is a diagram showing the way a read setting value is converted into a QR code. In encoding, one setting value may be converted into one QR code, or in a case where the amount of information on one setting value is large, and therefore, the setting value cannot be converted into one QR code, the setting value may be converted into a plurality of QR codes. Further, a plurality of setting values may be encoded en bloc into one QR code. In setting data 401 shown in FIG. 4, a hash tag represents the hierarchy of a category and each hierarchy corresponds to a menu structure of a setting UI screen (see FIG. 5) that is displayed on the operation unit 107 of the multi-function peripheral 100. In FIG. 4, “Settings” with one hash tag corresponds to a menu “Settings” in the highest hierarchy on the setting UI screen shown in FIG. 5. Then, “Machine Settings” with two hash tags corresponds to a menu “Machine Settings” in the lower hierarchy (second hierarchy) thereof. Further, “E-mail Address Book” and “E-mail Group” with three hash tags correspond to menus “E-mail Address Book” and “E-mail Group”, respectively, in the lower layer (third hierarchy) thereof.

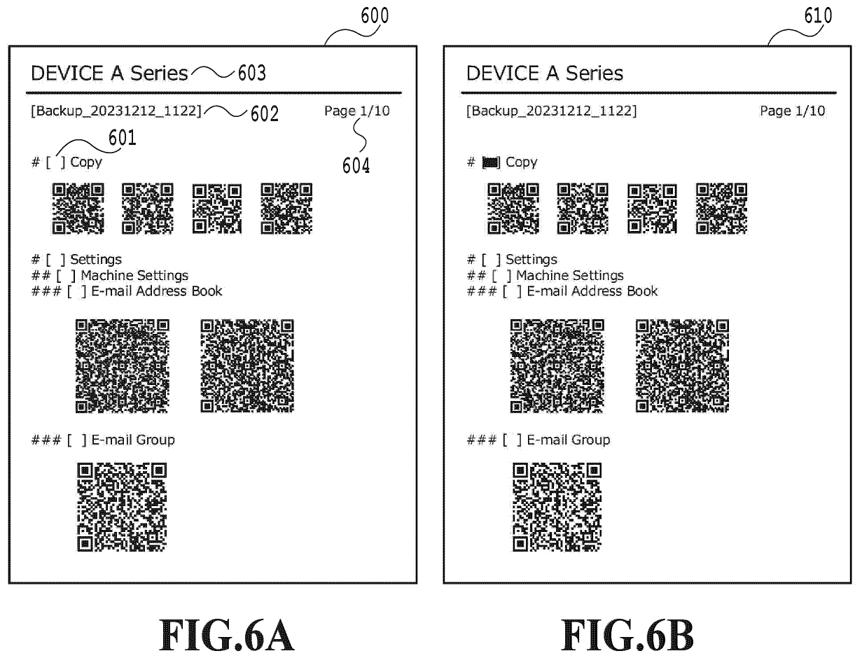

At S303, the setting data management unit 215 generates a backup image of setting data based on the code information generated at S302. FIG. 6A is a diagram showing one example of the backup image corresponding to the setting data 401 in FIG. 4. In a backup image 600 in FIG. 6A, a checkbox 601 for designating a setting value desired to be applied is provided between the hash tag indicating the hierarchy of the category and the category name. Then, in addition to the QR code obtained by encoding the setting value, a character string 602 representing the date of the execution of the backup, a character string 603 representing the name and model type of the apparatus of its own, and a character string 604 representing the page number are also described. Here, “Page 1/10” of the character string 604 indicates that the total of ten pages are included and the backup image may extend across a plurality of pages. The data of the generated backup image is converted into printing image data by being subjected to predetermined image processing in the CPU 201 and delivered to the printer control unit 213.

At S304, the printer control unit 213 obtains printing image data corresponding to the backup image generated at S303 from the CPU 201 and causes the printer unit 112 to perform print processing.

The above is the contents of the backup processing of setting data. In the following, the sheet on which the backup image is printed, which is obtained by this backup processing, is called “backup sheet”. In the present embodiment, a blank checkbox is provided on the assumption that a user designates a setting value that is applied by inputting a checkbox with a pencil or the like to the sheet on which the backup image is printed, but the designation method is not limited to this. For example, it may also be possible to insert a step of causing a user to select a restoration-target setting value on the UI and then print the checkbox in the state where a checkmark has been input. In this case, it is no longer necessary for a user to manually input a checkmark to the checkbox of the setting value that needs restoration.

### <<During Restoration>>

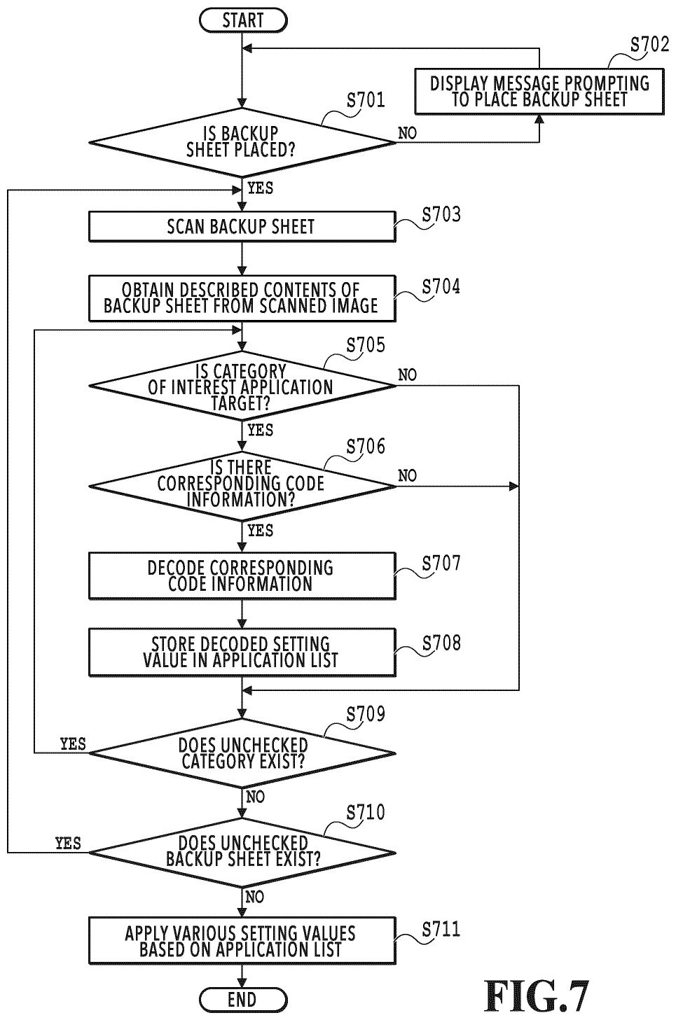

Next, with reference to the flowchart in FIG. 7, restoration processing of setting data is explained, which is performed by the multi-function peripheral 100 according to the present embodiment. Here, the original meaning of “restoration” is to restore an apparatus or the like to its original state, and therefore, a case where the setting data of an already-existing apparatus is applied to a new apparatus at the time of extension of facility is not restoration in a strict sense, but in the present specification, such a case is also called “restoration” for convenience. That is, in the present embodiment, the restoration-target information equipment may be the same equipment physically the same as the information equipment for which the above-described backup processing has been performed or may be different equipment of the same model. It is only required for the information equipment to be equipment to which the backed-up setting data can be applied. The flowchart in FIG. 7 is implemented by the CPU 102 executing a predetermined program. The CPU 102 starts the flowchart with the reception of user instructions to start restoration processing, which are given on a UI screen not shown schematically, via the operation unit I/F 106 as a trigger. Alternatively, the CPU 102 may start the flowchart with the reception of the same instructions given through a Web browser via the network I/F 108 as a trigger. In the following explanation, a symbol “S” means a step.

At S701, whether a reading-target sheet is placed on the document table of the scanner unit 111 is determined by using a document sensor (not shown schematically) provided within the scanner unit 111. FIG. 6B is one example of a backup sheet 610 in the state where the checkmark is input to the checkbox of the category name “Copy”, which is the target of restoration. In the example in FIG. 6B, the mark is input by a user blacking out the inside of the checkbox on the backup sheet with, for example, a pencil or the like. However, the method of inputting a mark is not limited to this and for example, a circle or checkmark may be input and as long as it is possible to identify the category of the setting value that needs restoration, any mark may be used. In a case where a backup sheet on which a mark based on user instructions has been input is placed on the document table, S703 is performed and in a case the backup sheet is not placed, S702 is performed.

At S702, processing to prompt a user to place the backup sheet is performed. For example, processing to display a message screen prompting a user to place the backup sheet along with an illustration of the document table on the display of the operation unit 107 and so on is performed.

At S703, the scanner control unit 212 causes the scanner unit 111 to read the backup sheet. Due to this, a scanned image of the backup sheet in the state where the checkmark is input to the checkbox of the category of the setting value desired to be restored is generated.

At S704, the setting data management unit 215 obtains the described contents of the backup sheet by analyzing the scanned image obtained at S703. Specifically, the setting data management unit 215 determines the presence/absence of the checkmark in the checkbox provided for each setting item, identifies the date of backup and the page number, and so on. The image analysis method necessary to obtain these described contents, for example, such as OCR (Optical Character Recognition) and pattern recognition, is a well-known technique, and therefore, explanation is omitted.

At S705, based on the analysis results at S704, the processing that is performed next is allocated in accordance with whether the category on which attention is focused (in the following, described as “category of interest”) is the application target. Here, in a case where the checkmark is input to the checkbox of the category of interest, it is the application target, and therefore, S706 is performed next. On the other hand, in a case where the checkmark is not input to the checkbox of the category of interest, it is not the application target, and therefore, S706 to S708 are skipped and S709 is performed.

At S706, the processing that is performed next is allocated in accordance with whether there is code information corresponding to the category of interest. In a case where there is code information corresponding to the category of interest, S707 is performed next. On the other hand, in a case where there is not code information corresponding to the category of interest, S707 and S708 are skipped and S709 is performed. For example, in the example in FIG. 6B described previously, for “Settings” with one hash tag and “Machine Settings” with two hash tags, the corresponding code information does not exist, and therefore, in this case, S707 and S708 are skipped.

At S707, the code processing unit 214 decodes the code information associated with the category of interest and obtains its setting value. In this case, on a condition that there are a plurality of pieces of code information corresponding to the category of interest, the code processing unit 214 decodes all the pieces of code information. The setting value (in the following, called “decoded setting value” for convenience) of the category of interest, which is obtained by the decoding, is delivered to the setting data management unit 215.

At S708, the setting data management unit 215 stores the decoded setting value obtained at S707 in association with its category in a list (in the following, called “application list”) in which the setting value to be applied to the apparatus of its own is stored. This application list is stored in the RAM 103.

At S709, based on the analysis results at S704, the processing that is performed next is allocated in accordance with whether all the categories have been checked. In a case where there is an unchecked category, the processing returns to S705 and the next category of interest is determined and then the same processing is continued. On the other hand, in a case where all the categories have been checked, S710 is performed next.

At S710, the processing that is performed next is allocated in accordance with whether all the backup sheets have been read. This determination may also be performed by displaying a UI screen (not shown schematically) for a user to give instructions to complete the reading of the backup sheet to the operation unit 107 and based on the user operation via the UI screen. Alternatively, it may also be possible to determine that all the pages have been read in a case where the number of read pages is counted and the count number reaches the page number of the backup sheet obtained at S704. In a case where there is a backup sheet that has not been read yet, the processing returns to S703 and the backup sheet is read. On the other hand, in a case where all the backup sheets have been read, S711 is performed next.

At S711, the setting data management unit 215 applies the various setting values to the apparatus of its own based on the application list stored in the ROM 103. After the application, the apparatus main body or specific software is rebooted as needed.

The above is the contents of the restoration processing according to the present embodiment. In a case where the results of analyzing the scanned image at S704 reveal that the sheet that is placed is not an appropriate backup sheet, it may also be possible to notify a user of this and prompt the user to perform the restoration processing again.

### Modification Example 1

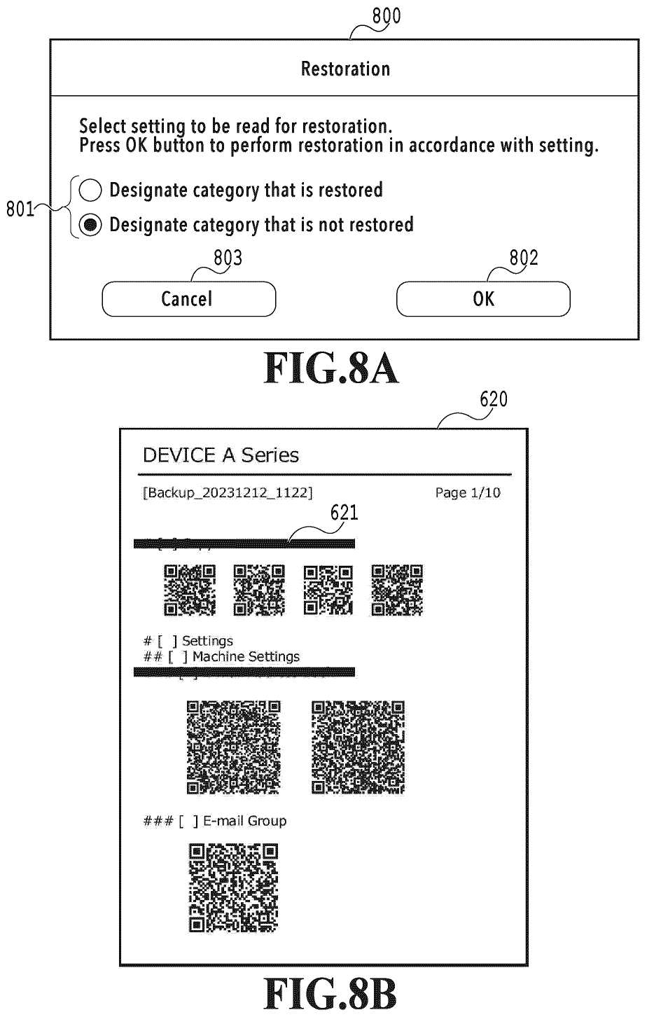

In the above-described embodiment, by a user inputting the checkmark to the checkbox of the category of the setting value desired to be applied, the setting value to be applied is identified among the many setting values. However, in a case where the number of categories of the setting values desired to be applied is large, the work to input the checkmark to the checkboxes of all the categories may be a heavy load for a user. Consequently, it may also be possible to identify the category of the setting value to be applied by inputting the checkmark to the checkbox of the category of the setting value that is not applied. FIG. 8A is a diagram showing one example of a restoration UI screen (restoration screen) according to the present modification example. A restoration screen 800 is displayed, for example, by tracing screens from an execution menu screen, not shown schematically, which is displayed on the operation unit 107, or by pressing down hard keys, not shown schematically, configuring the operation unit 107 in a specific order. On the restoration screen 800 in FIG. 8A, there are radio buttons 801 for a user to exclusively select whether to designate a category desired to be applied or designate a category desired not to be applied. Further, there are an “OK” button 802 for causing restoration to be performed and a “Cancel” button 803 for cancelling restoration. In a case where a user selects “Designate category that is not restored” with the radio button 801, at S705 in the flow in FIG. 7 described previously, the category with the input checkmark is no longer determined to be the application target. That is, the category without the input checkmark is determined to be the application target. In a case where the number of categories desired to be applied is smaller, it is recommended for a user to select “Designate category that is restored” with the radio button 801. For example, as shown in FIG. 8B, for the setting value for which restoration is not necessary, it may also be possible to input a mark that fills in the hash tag, inclusive of the character string representing the category name. What is required is that it is possible to identify categories for which restoration is necessary and categories for which restoration is not necessary. According to the present modification example, it is possible for a user to more efficiently designate a setting value that is taken as the target of restoration from among the many setting values. That is, according to the present disclosure, it is possible to selectively apply setting data a user desires to apply to target equipment among the conventional setting data.

### Modification Example 2

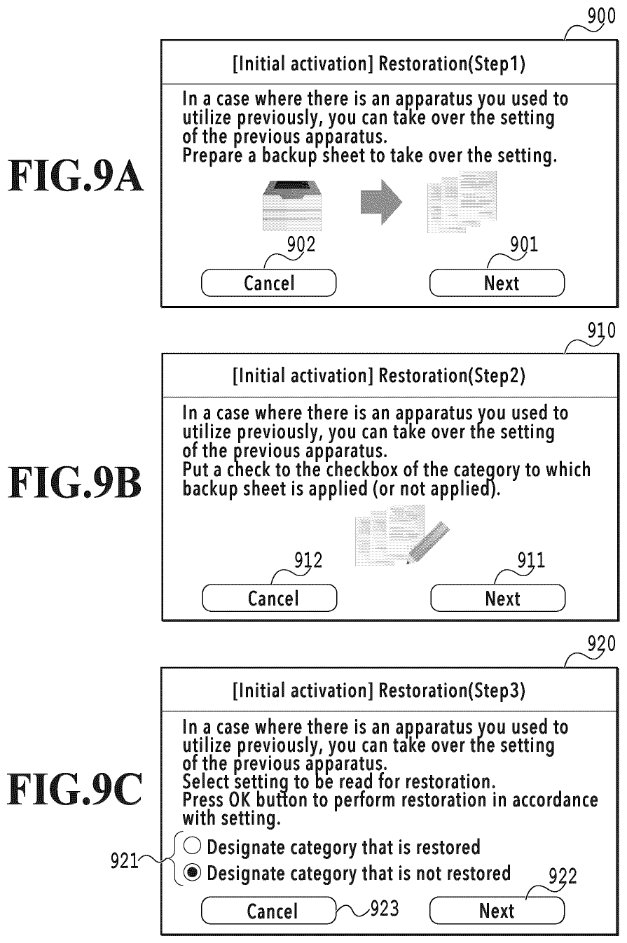

In the above-described embodiment, the restoration processing is started with user instructions via the UI screen as a trigger, however, for example, there is a possibility that a user unintentionally starts the setting of various setting values manually in a case of introducing a new facility. Consequently, it may also be possible to display a guide at the time of the first activation of restoration-target equipment. FIG. 9A to FIG. 9C are each a diagram showing one example of a restoration guide UI screen (restoration guide screen) that is displayed at the first time of activation. First, a first screen 900 shown in FIG. 9A is displayed first in a case where, for example, a multi-function peripheral is activated for the first time. This first screen 900 is a UI screen that prompts preparation of a backup sheet in a case where there exists another multi-function peripheral from which setting data is taken over and includes a “Next” button 901 for advancing the processing to the next step and a “Cancel” button 902 for cancelling restoration processing. In a case where a user completes preparation of a backup sheet and presses down the “Next” button 901, the screen makes a transition to a second screen 910 shown in FIG. 9B. This second screen 910 is a screen that prompts the input of the checkmark to the backup sheet prepared in a case where the first screen is displayed and includes a “Next” button 911 for advancing the processing to the next step and a “Cancel” button 912 for cancelling restoration processing. In a case where a user completes the input of the checkmark to the backup sheet and presses down the “Next” button 912, the screen makes a transition to a third screen 920 shown in FIG. 9C. This third screen 920 is a screen that prompts restoration processing using the backup sheet with the input checkmark, which is prepared in a case where the second screen 910 is displayed, and corresponds to the restoration screen 800 shown in FIG. 8 described previously. That is, on the third screen 920, there are radio buttons 921 for a user to select the category designation method, an “OK” button 922 for starting the execution of restoration processing, and a “Cancel” button 923 for cancelling restoration processing. The meaning of each button is the same as that on the restoration screen 800 in FIG. 8 described previously, and therefore, explanation is omitted. According to the present modification example, it is possible to prevent a user from forgetting restoration processing and starting the setting of various setting values manually in introducing a new facility and the like.

### Modification Example 3

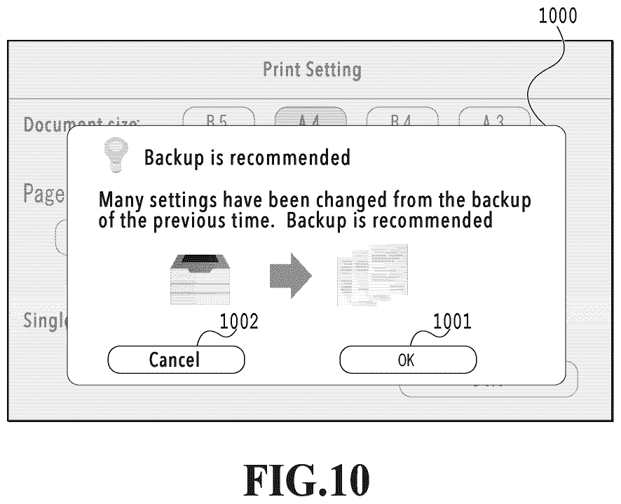

It is desirable for the various setting values to be taken as the restoration target to be most recent values. Because of that, in a case where a user or an administrator changes a setting value, it is desirable to back up the setting value each time, but there is a possibility that a user forgets to back up the setting value. Consequently, it may also be recommended to display a guide that prompts the execution of backup processing in a case where a user or the like changes a setting value. FIG. 10 is a diagram showing the way a message screen 1000 that prompts the execution of backup processing is displayed in a popup manner. On the message screen 1000, there are an “OK” button 1001 for causing backup to be executed and a “Cancel” button 1002 for leaving backup unexecuted. For example, in a case where the number of times the setting value is changed exceeds a threshold value, the popup display as shown in FIG. 10 is produced. The threshold value in this case may be fixed or variable. Further, as the method of counting the number of times the setting value is changed, it may also be possible to simply increment (+1) the count each time of change, or it may also be possible to store the changed setting item and the setting contents and decrement (−1) in a case where the setting contents are returned. By producing a UI display that prompts a user to perform backup at timing at which the setting value is changed as described above, it is possible to bring the restoration-target setting data into a most recent state or an equivalent state thereof.

### Other Modification Examples

In the above-described embodiment, a user manually inputs the checkmark to the checkbox of the category of the setting value desired to be applied, but this is not limited. For example, it may also be possible to enable a user to select a desired setting value via a UI screen, not shown schematically, at the time of backup and generate a backup image in the state where the checkmark is input in advance to the checkbox of the category of the setting value selected by the user.

Further, in the above-described embodiment, the setting value is converted into code information at the time of backup, but it may also be possible to print the character string as it is. Further, it may also be possible to generate a backup image with code information, such as a QR code, and a character string existent in a mixed manner.

As above, according to the present embodiment, it is possible to selectively apply only the setting value a user desires to restore among the conventional setting data to target information equipment.

### Second Embodiment

Depending on the category of setting data, there exists a case where it is not possible to set a child setting value unless a parent setting value is set correctly (or a case where a function that should be obtained originally is not obtained by setting). For example, in a case where a restoration-target multi-function peripheral has a file-server function, it is assumed that a user desires to set the function to “valid”. In this case, it is absolutely necessary to use a fixed IP address and set an IP address in using the fixed IP address. In this case, the relationship is such that the setting relating to use of the fixed IP address and the IP address that is used in using the fixed IP address is the parent setting and the setting relating to the file-server function is the child setting. Consequently, an aspect is explained as the second embodiment in which in a case where the parent-child relationship exists between the restoration-target setting values, the presence/absence of the application of the parent setting is checked and on a condition that the application of the parent setting cannot be checked, a user is notified of this. In the following, explanation of the contents common to those of the first embodiment is omitted and the restoration processing is explained, which is the different point.

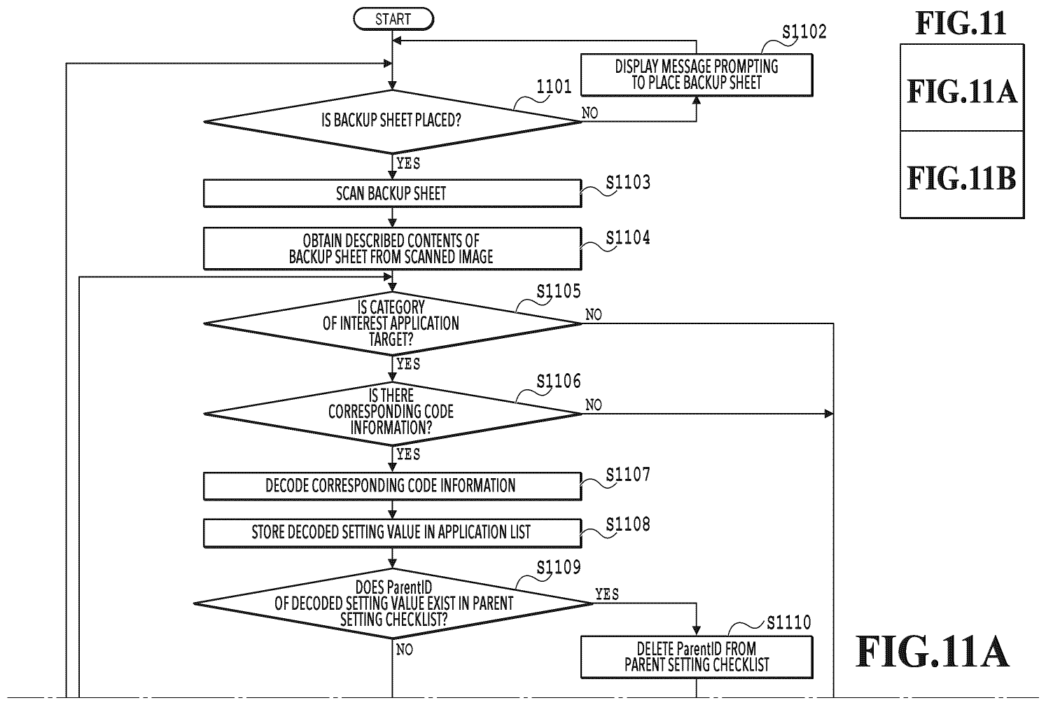

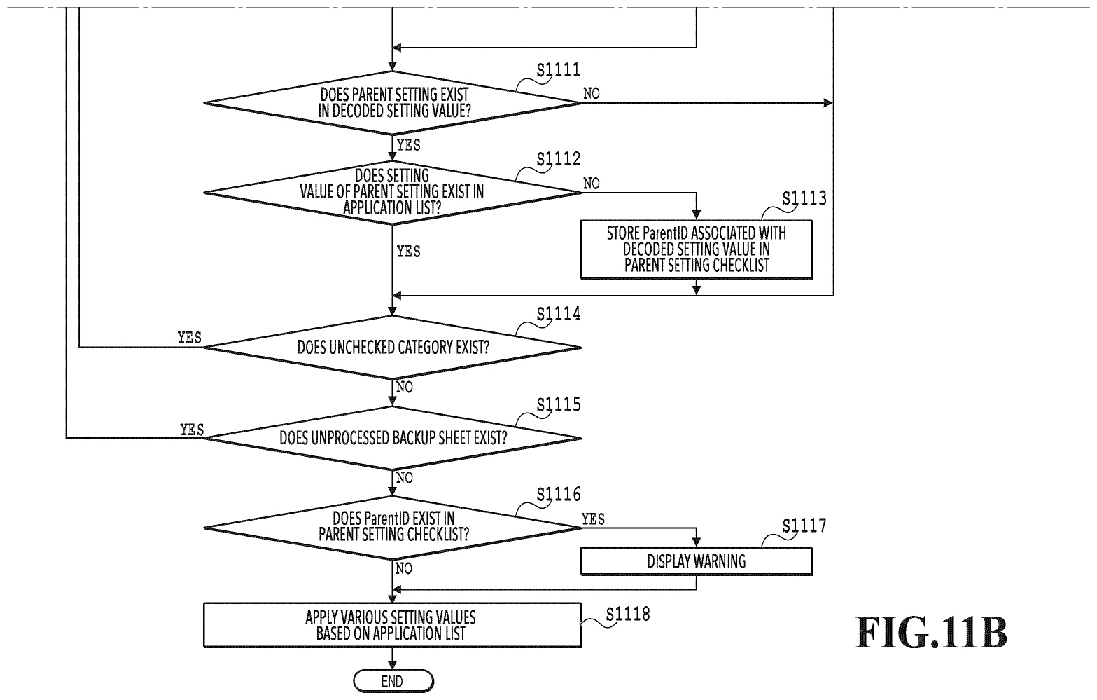

FIGS. 11A and 11B are flowcharts showing a flow of the restoration processing according to the present embodiment. In the following, explanation is given along the flow in FIGS. 11A and 11B. Each piece of the processing at S1101 to S1108 corresponds to that at S701 to S708 in the flow in FIG. 7 described previously and there is not a difference in particular, and therefore, explanation is omitted.

S1109, the processing that is performed next is allocated in accordance with whether ParentID associated with the decoded setting value obtained at S1107 exists in a parent setting checklist. Here, the parent setting checklist is a list for checking whether the setting value of the parent setting for the decoded setting value stored in the application list at S1108 is already stored in the application list and is created at S1113, to be described later. Further, ParentID is an identifier indicating being a parent setting, which is appended in advance to a certain setting value in a relationship of the parent setting for the certain setting value. In the present embodiment, it is assumed that in a case where the setting value of a child setting in the above-described parent-child relationship is backed up, the setting value is encoded in the state where ParentID capable of identifying the parent setting thereof is associated and code information is generated. In a case where ParentID exists within the parent setting checklist, S1110 is performed next and in a case where ParentID does not exist, S1111 is performed next.

At S1110, ParentID associated with the decoded setting value obtained at S1107 is deleted from the parent setting checklist. Due to this, in a case where the parent setting exists for the decoded setting value stored in the application list, the storage of the setting value of the parent setting as well in the application list is guaranteed. At S1111, the processing that is performed next is allocated in accordance with whether the parent setting exists for the decoded setting value obtained at S1107. In a case where the parent setting exists for the decoded setting value, S1112 is performed next and in a case where the parent setting does not exist, S1114 is performed next.

At S1112, the processing that is performed next is allocated in accordance with whether the setting value of the parent setting of the decoded setting value exists in the application list. By checking whether the setting value of the parent setting of the decoded setting value exists in the application list, the application of the decoded setting value, which is the child setting, is guaranteed. In a case where the setting value of the parent setting of the decoded setting value exists in the application list, S1114 is performed next and in a case where the setting value does not exist, S1113 is performed next. Then, at S1113, ParentID associated with the decoded setting value is stored in the parent setting checklist.

Each piece of processing at S1114 and S1115 that follow correspond to that at S709 and S710 in the flow in FIG. 7 described previously and there is not a difference in particular, and therefore, explanation is omitted.

After the reading of all the backup sheets is completed, at S1116, the processing that is performed next is allocated in accordance with whether ParentID exists in the parent setting checklist. In a case where ParentID remains in the parent setting checklist, S1117 is performed next and in a case where ParentID does not remain, S1118 is performed next. Then, at S1117, based on ParentID remaining in the parent setting checklist, processing to display a warning screen (not shown schematically) on the operation unit 107 is performed. This warning screen is a screen for notifying a user that there exists a setting value that cannot be applied because there is no setting value of the parent setting and for example, information on the parent setting that is necessary may be displayed along with a warning message. Further, it may also be possible to display a UI screen that prompts a user to input a setting value of the necessary parent setting in place of the warning screen. Alternatively, it may also be possible to check a user for the intention to apply the setting value relating to the warning and display a UI screen on which a user is caused to select the continuation of application or the abandonment of application.

The processing at S1118 corresponds to that at S711 in the flow in FIG. 7 described previously and there is not a difference in particular, and therefore, explanation is omitted.

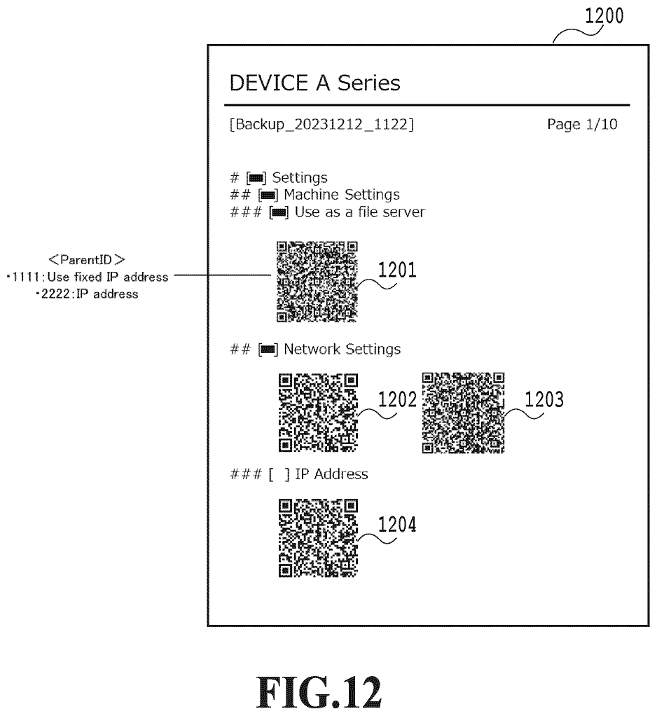

The above is the contents of the restoration processing according to the present embodiment. Here, a specific flow of the restoration processing of the present embodiment is explained by taking a backup sheet to which a checkmark has been input shown in FIG. 12 as an example. Here, on a backup sheet 1200 in FIG. 12, under the category “Settings” in the highest hierarchy, “Machine Settings” and “Network Settings” exist as the second hierarchy category. Further, under “Machine Settings”, “Use as a file server” exists as the third hierarchy category and under “Network Settings”, “IP Address” exists as the third hierarchy category. Then, among each checkbox, only the checkbox of “IP Address” is in the state where a checkmark has not been input. In this case, the processing advances as follows.
1) First, “Settings” in the highest hierarchy and the first “Machine Settings” in the second hierarchy are processed in order as the category of interest. For each of them, corresponding code information does not exist (NO at S1106), and therefore, the processing moves to the processing that takes “Use as a file server” in the next third hierarchy as the category of interest.
2) “Use as a file server” in the third hierarchy is the setting item relating to the function that utilizes the target equipment as the file server. Here, in a corresponding QR code 1201, “valid” is encoded as its setting value and the contents are obtained as the decoded setting value and stored in the application list (S1107, S1108). Further, from the QR code 1201, ParentID identifying the setting value of the parent setting that is necessary in a case where the function that utilizes the target equipment as the file server is “valid” is also obtained by decoding. Specifically, ParentID “1111” corresponding to the setting value “Use fixed IP Address” and ParentID “2222” corresponding to the setting value “IP Address” are obtained. These ParentIDs are not stored yet in the parent setting checklist (NO at S1109) at the point in time immediately after they are obtained, but they are stored in the parent setting checklist at S1113 after S1111 that follows S1109 at which the determination results are YES and S1112 that follows S1111 at which the determination results are YES.
3) Next, the second “Network Settings” in the second hierarchy is processed as the category of interest. This “Network Settings” include two kinds of setting value “Use fixed IP Address” and “Use DHCP” in an exclusive relationship to each other. “Use fixed IP Address” is the setting value representing the use of a fixed IP address and “Use DHCP” is the setting value representing the use of the function of automatically allocating an arbitrary IP address each time connection to a network is established. DHCP is an abbreviation of “Dynamic Host Configuration Protocol”. In a case where the function of utilizing the target equipment as a file server is made valid, the setting value of “Network Settings” must be “Use fixed IP Address” and further, a numerical value string representing the IP address that is used in that case is also necessary. Consequently, in a case where the setting value of “Use as a file server” in the third hierarchy is “valid”, each setting value of “Use fixed IP Address” and “IP Address” is the setting value of the parent setting of “Use as a file server”. In FIG. 12, a QR code 1202 is obtained by encoding “valid” as contents of the setting value “Use fixed IP Address”. Further, a QR code 1203 is obtained by encoding “invalid” as contents of the setting value “Use DHCP”. Here, to the checkbox of “Network Settings”, a checkmark has been input. Consequently, the two QR codes 1202 and 1203 are decoded and in the application list, as the decoded setting value of “Use fixed IP Address”, “valid” is stored (YES at S1106, then S1107, S1108). Then, at this point in time, in the parent setting checklist, two ParentIDs “1111” and “2222” associated with the decoded setting value are stored. Consequently, ParentID “1111” corresponding to “Use fixed IP Address” whose setting value is stored is deleted from the parent setting checklist (YES at S1109, then S1110). Then, in the QR code 1202, information other than “valid” representing the contents of “Use fixed IP Address” is not encoded (information on ParentID is not included), and therefore, the routine is exited (NO at S1111).
4) In the next routine, a QR code 1204 obtained by encoding a numerical value string (for example, (192.168.xx.xx)) representing the category “IP Address” should be decoded originally. However, here, to the checkbox of the category “IP Address”, a checkmark has not been input. Consequently, the routine is exited (NO at S1115) without the QR code 1204 being decoded. As a result of that, ParentID “2222” remains in the parent setting checklist (YES at S1116) and a warding display is produced (S1117). Upon receipt of this warning display, a user causes a backup sheet in the state where a checkmark has been input to the checkbox of “IP Address” to be read again, and so on. Due to this, all the necessary setting values are applied appropriately (S1118).

As above, according to the present embodiment, it is possible to prevent a failure in applying setting data in a case where the setting value that is taken as a child cannot be set unless the setting value that is taken as a parent is set correctly.

### Other Modification Examples

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-008644, filed Jan. 24, 2024, which is hereby incorporated by reference wherein in its entirety.

What is claimed is:

1. An information processing apparatus comprising:
one or more memories storing instructions;
one or more processors that, upon execution of the stored instructions, configures the one or more processors to function as:
an obtaining unit configured to obtain, from a scanned image of a sheet on which information on various setting values applicable to the information processing apparatus is printed, the various setting values; and
an application unit configured to apply, to the information processing apparatus, a setting value designated by a user from among the various setting values based on the information obtained from the scanned image.

2. The information processing apparatus according to claim 1, wherein execution of the stored instructions further configures the one or more processors to operate as:
a reception unit configured to receive instructions of a user corresponding to a setting item in the information processing apparatus; and
a determination unit configured to determine, based on the received instructions, which setting value from among the various setting values is to be applied for each setting item, wherein
the application unit applies a setting value for the setting item determined to be applied.

3. The information processing apparatus according to claim 2, wherein
the determination unit determines a setting value from among the various setting values based on the presence/absence of a checkmark in a checkbox on the sheet included in the scanned image.

4. The information processing apparatus according to claim 3, wherein
the determination unit determines that a setting value from among the various setting values of a setting item having a checkmark in a checkbox is the setting value to be applied to the information processing apparatus.

5. The information processing apparatus according to claim 3, wherein execution of the stored instructions further configures the one or more processors to operate as:
a warning unit configured to warn a user when a setting value from among the various setting values for a setting item that is determined to be applied to the information processing apparatus, a setting value for parent setting thereof is not determined to be applied to the information processing apparatus.

6. The information processing apparatus according to claim 5, wherein
the warning unit provides a notification of information relating to the parent setting along with the warning.

7. The information processing apparatus according to claim 1, wherein execution of the stored instructions further configures the one or more processors to operate as
in information on the various setting values, code information obtained by encoding a setting value is included and
a decoding unit configured to decode code information from the information on the various setting values that was encoded on the sheet in the scanned image.

8. The information processing apparatus according to claim 1, wherein execution of the stored instructions further configures the one or more processors to operate as
a notification unit configured to provide a notification prompting a user to apply various setting values by generating the scanned image from the sheet at a first time of activation of the information processing apparatus.

9. The information processing apparatus according to claim 1, further comprising:
a scanner unit configured to obtain the scanned image by scanning the sheet.

10. The information processing apparatus according to claim 1, further comprising:
a printer unit configured to print information on various setting values being applied to the information processing apparatus on a sheet based on user instructions.

11. The information processing apparatus according to claim 10, wherein execution of the stored instructions further configures the one or more processors to operate as:
a notification unit configured to provide a notification prompting a user to print the sheet when various setting values being applied to the information processing apparatus has changed more than a threshold value.

12. The information processing apparatus according to claim 10, wherein
the printing unit prints information on a specific setting value based on user instructions on a sheet among various setting values being applied to the information processing apparatus.

13. A control method of an information processing apparatus comprising:
obtaining, from a scanned image of a sheet on which information on various setting values applicable to the information processing apparatus is printed, the various setting values; and
applying, to the information processing apparatus, a setting value designated by a user from among the various setting values based on the information obtained from the scanned image.

14. A non-transitory computer readable storage medium storing a program that, when executed by one or more processors of an information processing apparatus, performs a control method comprising:
obtaining, from a scanned image of a sheet on which information on various setting values applicable to the information processing apparatus is printed, the various setting values; and
applying, to the information processing apparatus, a setting value designated by a user from among the various setting values based on the information obtained from the scanned image.
